(19) United States
(12) Patent Application Publication
(10) Pub. No.: US 2004/0228489 A1
(43) Pub. Date: Nov. 18, 2004

(54) Identification assigning method and apparatus

(75) Inventors: Noboru Ishibashi, Okazaki-shi (JP); Kunihiro Yamada, Okazaki-shi (JP)

Correspondence Address: OLIFF & BERRIDGE, PLC, P.O. BOX 19928, ALEXANDRIA, VA, 22320, US

(73) Assignee: AISIN AW CO., LTD., Anjo-shi (JP)

(21) Appl. No.: 10/810,669

(22) Filed: Mar. 29, 2004

(30) Foreign Application Priority Data
Apr. 18, 2003 (JP) 2003-114816

(51) Int. Cl. H04L 9/00

(52) U.S. Cl. 380/258

(57) ABSTRACT

A method makes it possible to use content, such as various types of data and programs, without causing failure in collecting royalties by enabling a unique ID to be set in an apparatus in which no ID is set during production. The method includes recording, in an apparatus, content which is made usable by recording a release key in the apparatus; recording, in the apparatus, ID setting instructions; executing the ID setting instructions; and creating an ID distinctive to the apparatus, the ID usable to acquire the release key.

### INCORPORATION BY REFERENCE

The disclosure of Japanese Patent Application No. 2003-114816 filed Apr. 18, 2003 including the specification, drawings, and claims is incorporated herein by reference in its entirety.

### BACKGROUND OF THE INVENTION

1. Field of Invention

The present invention relates to an identification (hereinafter, referred to as ID) assigning method.

2. Description of Related Art

In a conventional navigation apparatus mounted on a vehicle, such as an automobile, an operator, such as a driver, operates a predetermined input unit to designate a destination. Then, based on the destination and a present position of the vehicle which is detected by a positional detecting processor, a route from the present position to the destination is found and shown. In this case, the conventional navigation apparatus finds the route based on map data that includes search data and road data and that is stored in a storage medium such as a CD-ROM or a DVD-ROM. A map, based on the map data, is displayed on a screen of a display unit and route guidance is performed by displaying the found route on the map. In addition, at intersections, etc., audio guidance is also performed.

Furthermore, the conventional navigation apparatus can find various facilities, such as restaurants and hotels, based on the map data. In this case, information of a found facility is displayed on the screen of the display unit and its position is identified. Thus, a route to the found facility may be found by setting the found facility as a destination.

However, since the conventional navigation apparatus finds a route based on the map data stored in the storage medium, it cannot find an appropriate route when a new road is open to traffic. When a new facility is built, the navigation apparatus cannot find that facility because it is not included in the map data. When an existing facility is demolished, information of that facility that no longer exists and a route to that facility might be displayed. As a result, false information is supplied to the operator.

Japanese Unexamined Patent Application Publication No. 11-257975, which is incorporated herein by reference, discloses a conventional navigation apparatus that allows a user to switch the storage medium to one storing new map data and that can update the map data by using communication means. As a result, it possible to find an appropriate route and to find an appropriate facility, even if a new road is open to traffic, a new facility is built, or an existing facility is demolished.

In the above-described conventional navigation apparatus, however, an ID must be set. The navigation apparatus can switch the storage medium to one storing new map data and/or download new map data. Accordingly, in the case of a navigation apparatus in which no ID is set when the navigation apparatus is produced in a factory, the navigation apparatus cannot update the map data.

In some cases, even in a conventional navigation apparatus in which the ID is not set, it may be possible to enable updating of map data. In this case, however, a royalty on the new map data cannot be appropriately collected.

### SUMMARY OF THE INVENTION

As a result, various exemplary embodiments of this invention provide, among other things, an ID assigning method, that enables a unique ID to be set in an apparatus that does not have an ID set therein during the production stage. Therefore, updated content, such as various types of data and programs, is available to the apparatus without the possibility that royalties will not be collected.

Therefore, various exemplary embodiments of this invention provide an ID assigning method, including recording, in an apparatus, content which is made usable by recording a release key in the apparatus; recording, in the apparatus, ID setting instructions; executing the ID setting instructions; and creating an ID distinctive to the apparatus, the ID usable to acquire the release key.

Various exemplary embodiments of the invention provide an ID assigning method, including recording, in an apparatus, ID setting instructions for creating an ID distinctive to the apparatus; determining a date and time; determining a present position; executing the ID setting instructions; and creating the ID based on data representing the date and time, and data representing the present position.

Various exemplary embodiments of the invention provide an ID assigning apparatus, including a controller, the controller configured to record, in the apparatus, content which is made usable by recording a release key in the apparatus; record, in the apparatus, ID setting instructions; execute the ID setting instructions; and create an ID distinctive to the apparatus, the ID usable to acquire the release key.

Various exemplary embodiments of the invention provide a storage medium storing a set of program instructions executable on a data processing device and usable for assigning an ID to an apparatus, the set of program instructions including instructions for recording, in the apparatus, content which is made usable by recording a release key in the apparatus; instructions for recording, in the apparatus, ID setting instructions; instructions for executing the ID setting instructions; and instructions for creating an ID distinctive to the apparatus, the ID usable to acquire the release key.

### BRIEF DESCRIPTION OF THE DRAWINGS

Exemplary embodiments of the invention will now be described with reference to the accompanying drawings, wherein:

FIG. 1 is a flowchart showing the operation of a method setting an ID unique to a car-mounted apparatus according to a first exemplary embodiment of the invention;

FIG. 2 is a block diagram showing the structure of the car-mounted apparatus according to the first exemplary embodiment of the invention;

FIG. 3 shows a first example of a method for creating an ID unique to a car-mounted apparatus according to a second exemplary embodiment of the invention;

FIG. 4 shows a second example of a method for creating an ID unique to the car-mounted apparatus according to the second exemplary embodiment of the invention;

FIG. 5 shows a third example of a method for creating an ID unique to the car-mounted apparatus according to the second exemplary embodiment of the invention;

FIG. 6 is a flowchart showing the operation of an ID creating process according to the second exemplary embodiment of the invention;

FIG. 7 shows a method for creating an ID unique to a car-mounted apparatus according to a third exemplary embodiment of the invention; and

FIG. 8 shows a method for creating an ID unique to a car-mounted apparatus according to a fourth exemplary embodiment of the invention.

### DETAILED DESCRIPTION OF EXEMPLARY EMBODIMENTS

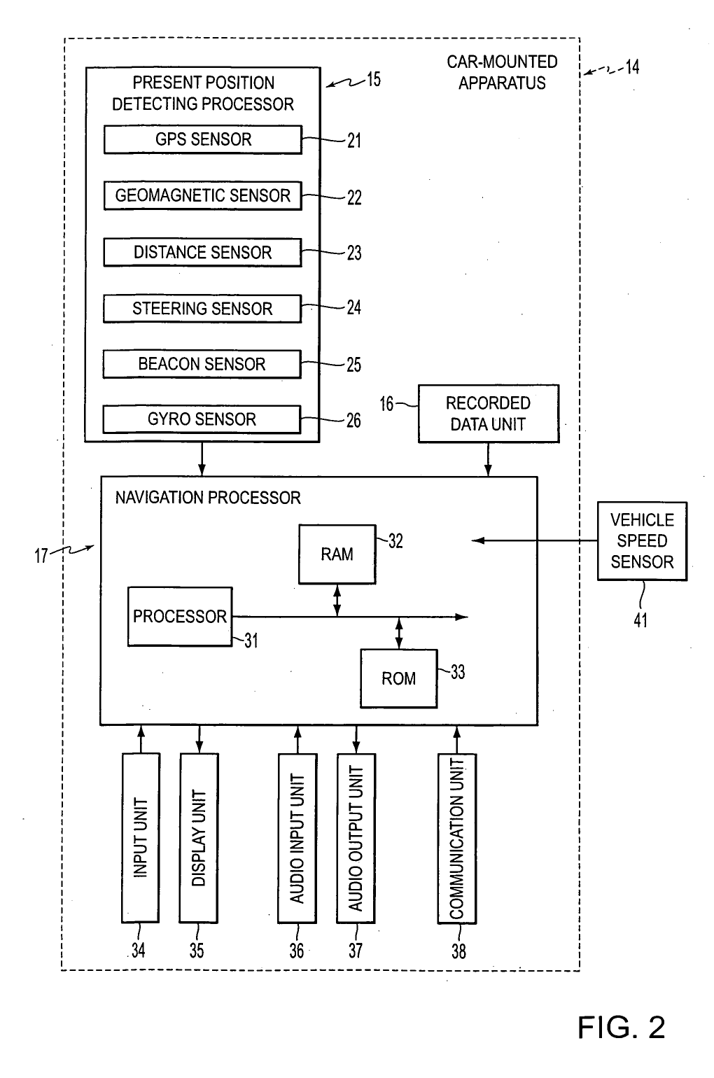

FIG. 2 is a block diagram showing the structure of a car-mounted apparatus according to a first exemplary embodiment of the invention.

Referring to FIG. 2, a car-mounted apparatus 14 is an apparatus which is mounted on a vehicle, such as a passenger car, a truck, a bus, or a motorbike, and which functions as a navigation apparatus. The car-mounted apparatus 14 is a type of computer including arithmetic means, such as a CPU and an MPU; storage means, such as a semiconductor memory and a magnetic disk; display means, such as a CRT, a liquid crystal display, an LED (Light Emitting Diode); input means, such as a keyboard, a joystick, a touch panel, push buttons, a rotary dial, and a remote controller; and an input/output interface.

The car-mounted apparatus 14 may not be mounted on a vehicle, or does not need to function as a navigation apparatus, and may be any type of apparatus that can use content; such as various types of data and programs, by updating or setting the content. The car-mounted apparatus 14 may be, for example, a personal computer, a cellular phone, a PHS (Personal Handy-Phone System) telephone, a telephone set of a stationary type, a PDA (Personal Digital Assistant), an electronic notebook, a portable information terminal, a game machine, a digital television, or the like.

In this embodiment, for ease of explanation, the car-mounted apparatus 14 is a navigation apparatus mounted on a vehicle. In this case, based on search data and map data including road data which are stored in a storage medium, the car-mounted apparatus 14 can perform, for example, finding a route, finding a facility, or the like, displaying a map on a display unit 35, which is described later, and displaying the found route, facility, or the like, on the map.

As shown in FIG. 2, the car-mounted apparatus 14 includes, for example, a present position detecting processor 15, for detecting the present position; a recorded data unit 16 having recorded road data, or the like; a navigation processor 17, for performing various arithmetic processes based on input information, such as a navigation process; an input unit 34, a display unit 35; an audio input unit 36; an audio output unit 37; and a communication unit 38. A vehicle speed sensor 41 is connected to the navigation processor 17.

The present position detecting processor 15 consists of a GPS (Global Positioning System) sensor 21, a geomagnetic sensor 22, a distance sensor 23, a steering sensor 24, a beacon sensor 25, a gyrosensor 26, and an altimeter (not shown). Some of the GPS sensor 21, the geomagnetic sensor 22, the distance sensor 23, the steering sensor 24, the beacon sensor 25, the gyrosensor 26, and the altimeter, may be combined or omitted, if desired, due to production cost, resources, or the like.

The GPS sensor 21 detects the present position on the earth by receiving radio waves generated by an artificial GPS satellite. By measuring magnetism, the geomagnetic sensor 22 detects the vehicle bearing. The distance sensor 23 detects the distance between predetermined positions on a road, or the like. As the distance sensor 23, for example, a sensor which measures the number of revolutions of a vehicle wheel (not shown) and that determines a distance based on the measured number of revolutions, a sensor that detects a distance by measuring an acceleration and integrating the acceleration twice, or the like, may be used.

The steering sensor 24 detects a steering angle. As the steering sensor 24, for example, an optical rotary sensor or rotary resistance sensor which is provided on a rotating part of a steering wheel which is (not shown) an angular sensor, or the like, may be used.

The beacon sensor 25 detects the present position by receiving positional information from beacons provided along the road. The gyrosensor 26 detects an angular rate of rotation of the vehicle, that is, an angle of traverse. As the gyrosensor 26, for example, a gas rate gyroscope, a vibrating gyroscope, or the like may be used. By integrating the angle of traverse detected by the gyrosensor 26, the bearing to which the vehicle is directed can be detected.

The GPS sensor 21 and the beacon sensor 25 can each separately detect the present position. By combining the distance detected by the distance sensor 23 and the bearing detected by the geomagnetic sensor 22 and the gyrosensor 26, the present position can also be detected. Also, by combining the distance detected by the distance sensor 23 and the steering angle detected by the steering sensor 24, the present position can be detected.

The recorded data unit 16 contains a database composed of a map data file, an intersection data file, a node data file, a road data file, a photo-data file, and a facility-information data file having, for example, recorded facility information such as hotels, gas stations, tourist information centers, in areas. In addition to route finding data, various types of data are recorded in the recorded data unit 16 which may be displayed, on the screen of the display unit 35, such as a guide map along the found route, characteristic photographs at intersections or on the route, the distance to the next intersection. Various types of data for outputting predetermined information by the audio output unit 37 are also recorded in the recorded data unit 16.

Intersection data, node data, and road data are recorded in the intersection data file, the node data file, and the road data file, respectively. Based on the intersection data, the node data, and the road data, road conditions are displayed on the screen. The intersection data includes intersection types, that is, for example, data about whether traffic lights are installed at an intersection. Also, the node data constitutes at least the positions and shapes of roads in the map data recorded in the map data file, and includes data representing actual road bifurcations (including intersections and T-junctions), node points, and links connecting node points. The node points represent at least bending points on the roads.

The road data includes data concerning the roads themselves, such as, for example, widths, gradients, cants, altitudes, banks, surface conditions, the numbers of lanes, points at which the number of lanes decreases, and points at which road widths narrow. In the case of express highways and arterial roads, for oncoming lanes, separate road data items are stored and processed as a pair of roads. For example, in the case of arterial roads each having four or more lanes, the road data is processed, wherein road data items for inbound lanes and outbound are respectively stored as separate roads. Corner data includes data concerning, for example, curvature radii, intersections, T-junctions, and comer entries. In addition, road attributes include data concerning, for example, crossing places, express-highway entry/exit ramp ways, express-way tollgates, descending surfaces, ascending surfaces, and road types (e.g., national routes, principal local roads, ordinary roads, express highways).

The navigation processor 17 includes a processor 31 for controlling the entirety of the car-mounted apparatus 14, a RAM 32 which is used as a working memory when the processor 31 performs various arithmetic processes, and a ROM 33 as a recording medium in which, in addition to control programs, various programs, for example, for finding routes to destinations, performing traveling guidance on the route, determining particular sections, and finding locations and/or facilities are recorded. The navigation processor 17 connects to the input unit 34, the display unit 35, the audio input unit 36, the audio output unit 37, and the communication unit 38. The navigation processor 17 performs various processes such as, for example, finding routes to destinations, performing traveling guidance on the route, determining particular sections, and finding locations and/or facilities. Some of the audio input unit 36, and the audio output unit 37, and the communication unit 38 may be combiner or omitted, if desired, due to production cost, resources, or the like.

The recorded data unit 16 and the ROM 33 include magnetic cores and semiconductor memories (not shown). Various recording media, such as, for example, magnetic tapes, magnetic disks, magnetic drums, CD-ROMs, CD-R/Ws, MDs, DVD-ROMs, DVD-R/Ws, DVD-RAMs, optical disks, MOs, IC cards, optical cards, memory cards, and stick memories, can be used as the data-recorded unit 16 and/or the ROM 33. The recording media may be installed in the car-mounted apparatus 14 beforehand, or may be easily replaced by a user, or the like.

The communication unit 38 transmits and receives various types of data to/from, for example, an FM transmitter, a telephone network, the Internet, a cellular phone network, or the like. The communication unit 38 receives, for example, various types of data such as, for example, road information concerning traffic jams, which is received by an information sensor or the like (not shown), traffic accident information, and D-GPS information detecting detection error of the GPS sensor 21.

Various programs and data for use with the car-mounted apparatus 14 can be transmitted from an information center (an Internet server, a navigating server, or the like) to a plurality of base stations (such as an Internet provider terminal, a communication station connected to the communication unit 38 through a telephone line, a communication line, or the like), and can be further transmitted from each base station to the communication unit 38. In the case of using this type of system, when at least part of the program and data transmitted from each base station is received, the processor 31 can download the received part to a readable/writable memory, for example, a recording medium such as the RAM 32, a flash memory, or a hard disk, and can perform various processes based on the data by activating the program. In this case, for example, the program and data can be recorded in different recording media (i.e., the different base stations) and can be recorded in a single recording medium in the car-mounted apparatus 14.

In addition, by using a personal computer, the program and data transmitted from the information center can be downloaded to a recording medium such as a memory card, a flexible disk, or the like, which is removable from the personal computer. Then, when the recording medium is transfixed to the car-mounted apparatus 14, by activating the program, various processes can also be performed based on the data.

The input unit 34 is used for, for example, correcting a position at the start of traveling and for inputting a destination, and includes, for example, operation keys, push buttons, a jog dial, and a cross key which are provided on the main body of the car-mounted apparatus 14. The input unit 34 may be a remote controller. When the display unit 35 is a touch panel, it is preferable that the touch panel includes operation switches displayed on the screen of the display unit 35, such as operation keys and an operation menu. In this case, similarly to an ordinary touch panel, inputting can be performed by pressing (touching) the operation switches.

Displayed on the screen of the display unit 35 are, for example, operation guidance, an operation menu, operation-key guidance, routes from the present position to a destination, and information of guidance along the routes. As the display unit 35, a CRT display, a liquid crystal display, an LED display, a plasma display, a hologram display unit that projects a hologram on a front glass, or the like, can be used.

The audio input unit 36 may be a microphone or the like (not shown), and can input necessary information through speech. The audio output unit 37 further includes a speech synthesizer and a speaker (not shown), and informs the operator by outputting, from the speaker, speech information, for example, guidance information and speed-change information, which is synthesized by the speech synthesizer. In addition to the speech synthesized by the speech synthesizer, various sounds, various types of guidance information recorded beforehand as sound on a tape or in a memory, or the like, may also be output from the speaker.

Various types of data can be recorded in the data-recorded unit 16, and various programs can be recorded in the ROM 33. According to this embodiment, content, such as the data recorded in the recorded data unit 16 and the programs recorded in the ROM 33, can be updated. For example, by using the communication unit 38 to download content, such as new versions of data and programs, from the information center, old version content, such as the data previously recorded in the recorded data unit 16 and the programs, recorded in the ROM 33, may be updated.

In addition, the old version content, such as the data recorded in the data-recorded unit 16 and the programs recorded in the ROM 33 may also be updated by connecting, a removable recording medium with, for example, the new version data and programs, recorded therein, such as a magnetic tape, a magnetic disk, a magnetic drum, a CD-ROM, a CD-R/W, an MD, a DVD-ROM, a DVD-R/W, a DVD-RAM, an optical disk, an MO, an IC card, a memory card, or a stick memory, to an interface (not shown) included in the car-mounted apparatus 14.

Furthermore, when the data-recorded unit 16 or the ROM 33 includes a removable recording medium, such as a magnetic tape, a magnetic disk, a magnetic drum, a CD-ROM, a CD-R/W, an MD, a DVD-ROM, a DVD-R/W, a DVD-RAM, an optical disk, an MO, an IC card, a memory card, or a stick memory, and content, such as data and programs, is recorded in the removable recording medium, at least a part of that content may be updated by replacing the removable recording medium with a removable recording medium having new version of the content recorded therein.

In this exemplary embodiment, it is assumed that, in the ROM 33 or another storage means, an ID for identifying the car-mounted apparatus 14 is not recorded. Conventionally, when it is necessary to set an ID in an apparatus such as a navigation apparatus, the ID can be recorded in a nonvolatile storage means, such as the ROM 33, during production. In the car-mounted apparatus 14 in this exemplary embodiment, however, it is assumed that no ID is set.

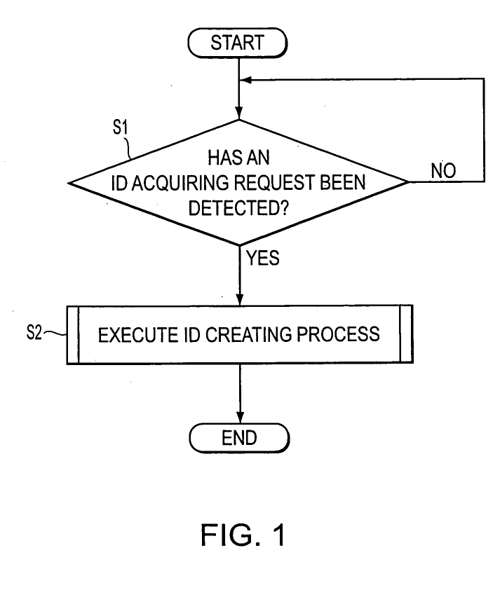

The operation of the car-mounted apparatus 14 will now be described. FIG. 1 is a flowchart showing an exemplary embodiment of an operation of a method for setting a unique ID in the car-mounted apparatus according to the first embodiment of the invention.

According to this example, an operation is described for a case in which map data, as the data recorded in the recorded data unit 16, is updated. The operator purchases a DVD-ROM as a recording medium having new version map data recorded therein and replaces a DVD-ROM having old version map data. It is assumed that, in the DVD-ROM, a program for setting a unique ID in the car-mounted apparatus 14 is also recorded as an ID setting program. It is also assumed that the new version map data recorded in the DVD-ROM is prevented from being directly read by the navigation processor 17 in the car-mounted apparatus 14. However, by inputting a predetermined release key, the DVD-ROM can be read by the navigation processor 17.

First, the operator purchases a DVD-ROM having the new version map data recorded therein. Then, the operator removes the DVD-ROM with the old version map data, which is the recording medium in the recorded data unit 16. The disk may be removed by, for example, pressing an ejection button on the car-mounted apparatus 14. Next, the operator places, in the recorded data unit 16, the purchased DVD-ROM with the new version map data. Accordingly, the program for setting the unique ID is read from the DVD-ROM and is activated by the navigation processor 17.

When the ID setting program is actuated, a setting screen is displayed on the screen of the display unit 35. The setting screen includes a start switch, and the operator operates the input unit 34 to select the start switch. For example, when the display unit 35 is a touch panel, the operator selects the displayed start switch by pressing (touching) it. This allows the navigation processor 17 to determine that an ID acquiring request has been detected, so that the navigation processor 17 executes an ID creating process in accordance with the program.

In the ID creating process in this exemplary embodiment, a randomly extracted code is created as an ID. The code is created based on a numeric value randomly acquired from 64-bit numeric data, and is formed by a combination of characters, such as numbers and letters, and symbols. The created ID is set as an ID for using the DVD-ROM having the new version data recorded therein.

The set ID is displayed on the screen of the display unit 35. The operator records the displayed ID, writes it on a predetermined form, and sends the form to a sales management center for the purchased DVD-ROM by means such as mailing. The ID is registered in the sales management center. Although an administrator of the sales management center is, for example, a manufacturer of the DVD-ROM, a sales agent, or the like, the administrator may be one entrusted by the manufacturer, the sales agent, or anyone else.

Then, a recording medium storing a predetermined release key is sent back from the sales management center to the operator by means such as mailing. The operator sets, in the data-recorded unit 16, the recording medium storing the release key, whereby the release key is read by the navigation processor 17. The release key enables the navigation processor 17 to read the new version map data recorded in the DVD-ROM.

The above-described exemplary process is summarized below with reference to the flowchart of FIG. 1.

As shown in FIG. 1, first, in step S1, a determination is made whether or not an ID acquiring request has been detected. If the request has been detected, the process proceeds to step S2. If not, the car-mounted apparatus 14 is on standby (i.e., returns to step S1). Then, in step S2, the ID creating process is executed.

The set ID may be posted from the operator to the sales management center by means such as e-mail, facsimile, or telephone. Also, when the release key is a code formed by a combination of characters, such as numbers, letters, and symbols, it may be posted from the sales management center to the operator by means such as e-mail, facsimile, or telephone. In this case, when the release key is set such that the operator operates the input unit 34 to input the code, the navigation processor 17 can read the new version map data.

The data to be updated may be data other than the map data, for example, data stored in the intersection data file, the node data file, the road data file, the photo-data file, and/or the facility data file. Furthermore, instead of the data, a program, such as, for example, the navigation program, can be updated.

The recording medium having the new version data and programs recorded therein may be one other than a DVD-ROM. For example, it may be a magnetic tape, a magnetic disk, a magnetic drum, a CD-ROM, a CD-R/W, an MD, a DVD-R/W, a DVD-RAM, an optical disk, an MO, an IC card, a memory card, a stick memory, or the like.

Also, when the car-mounted apparatus 14 can communicate with the information center and can download data and programs from a server such as an Internet server, a navigating server, or the like, which is provided in the information center, the car-mounted apparatus 14 can also download new version data and programs from the server. In this case, a program for setting the unique ID can be downloaded together with the new version data and programs.

The set ID is transmitted from the car-mounted apparatus 14 to the information center. The information center functions as a sales management center of the new version data and programs. After the ID is registered in the information center, the release key is transmitted from the information center to the car-mounted apparatus 14, and is set in the car-mounted apparatus 14. This enables the navigation processor 17 in the car-mounted apparatus 14 to use the downloaded new version data and programs.

This exemplary embodiment may be applied to cases other than updating of data and programs. For example, this embodiment can be also applied to a case in which completely new data and programs are set. Therefore, the setting of an ID by using the program for setting a unique ID, registration of the ID in the sales management center, and the setting of a release key sent from the sales management center enable use of the completely new data and programs.

Content that is set or updated in the car-mounted apparatus 14 may be content other than data and programs, for example, music, video images, news, television programs, or mail magazines. For example, when the car-mounted apparatus 14 can communicate with the information center through an Internet server, a navigating server, or the like, music, video images, news, television programs, and/or mail magazines are delivered to the car-mounted apparatus 14. Similarly, a program for setting a unique ID may be downloaded with the delivered music, video images, news, television programs, and/or mail magazines as well. The set ID is then transmitted from the car-mounted apparatus 14 to the information center and is registered in the information center, which functions as a sales management center. As a result, a release key transmitted from the information center and is set in the car-mounted apparatus 14. The release key makes it possible to use the downloaded content.

As described above, in this exemplary embodiment, when content, such as data and programs, is updated or newly set for use in the car-mounted apparatus 14, a unique ID can be created and set in the car-mounted apparatus 14. After the ID is registered in the sales management center or the like, a release key is sent. By setting the release key in the car-mounted apparatus 14, the content can be used.

Accordingly, even when no ID is set in the car-mounted apparatus 14 during production, a unique ID can be set. As a result, content can be used without causing failure in collecting royalties.

In other words, if the car-mounted apparatus 14 belonging to the operator is a model in which an ID is set in the production stage, a service that needs ID management, such as content updating, can be used by the operator. Also, if a manufacturer, a seller, or the like, of the car-mounted apparatus 14 provides a service, such as content updating, to the operator who possesses a model of the car-mounted apparatus 14 in which no ID is set in the production stage, ID management can be performed, thus ensuring collection of royalties in both cases.

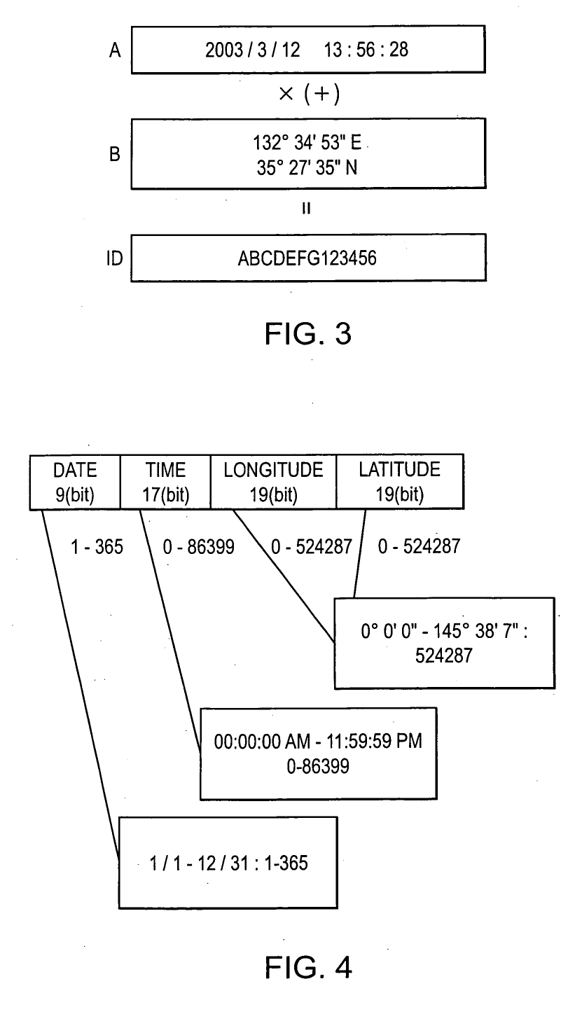

A second exemplary embodiment of the invention will now be described with reference to FIGS. 3-6. For those structures identical to those described in the first embodiment, identical reference numerals are used and their descriptions are omitted. Also, the operation and advantages identical to those in the first embodiment is omitted.

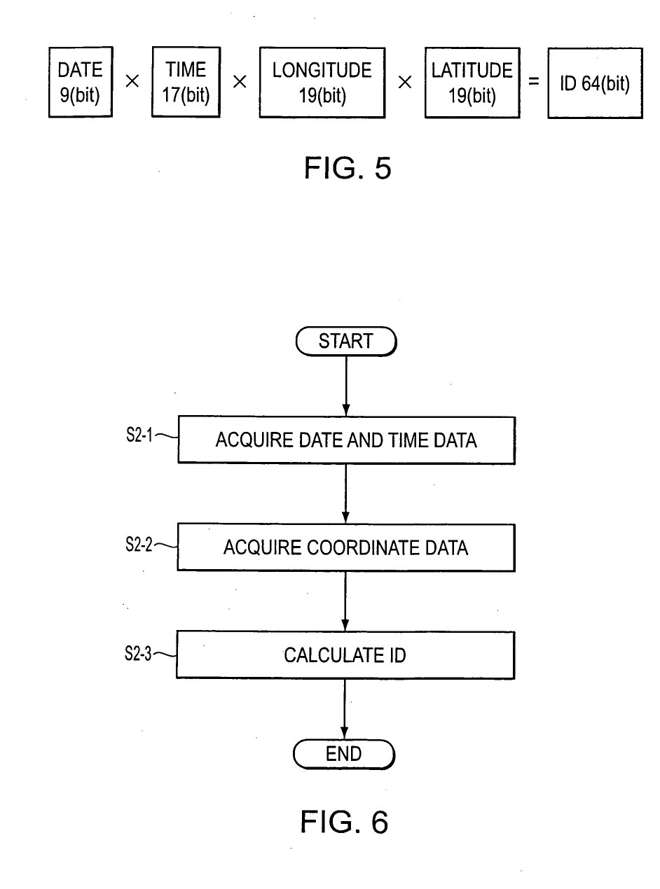

FIG. 3 shows a first example of a method for creating an ID unique to a car-mounted apparatus according to the second exemplary embodiment of the invention. FIG. 4 shows a second example of a method for creating an ID unique to the car-mounted apparatus according to the second exemplary embodiment of the invention. FIG. 5 shows a third example of a method for creating an ID unique to the car-mounted apparatus according to the second exemplary embodiment of the invention. FIG. 6 is a flowchart showing an operation in an ID creating process according to the second exemplary embodiment of the invention.

In the ID creating process in the first embodiment, a randomly extracted code is used to create an ID. Thus, it is possible that the same single ID may be set in different car-mounted apparatuses 14, even if the possibility is very low. Accordingly, in the ID creating process in this exemplary embodiment, an ID can be created based on data representing the present date and time and the present position.

In this case, as shown in FIG. 3, data A that is date-and-time data representing the present date and time, and data B that is coordinate data representing the present position of the car-mounted apparatus 14 are acquired. Data A and data B are added up or multiplied together to create an ID. Data A consists of a month, a day, a year, hours, minutes, and seconds, and is, for example, Mar. 12, 2003, 13:56:28, as shown in FIG. 3. Although data A can be acquired from a timepiece (not shown) included in the car-mounted apparatus 14, data A may preferably be acquired from GPS data emitted from the GPS satellite by the GPS sensor 21, in order to prevent falsification.

In addition, data B consists of latitude and longitude, and is, for example, longitude 132 degrees 34 minutes 53 seconds east and latitude 35 degrees 27 minutes 35 seconds north, as shown in FIG. 3. Although data B can be acquired from the geomagnetic sensor 22, the distance sensor 23, the steering sensor 24, the beacon sensor 25, the gyrosensor 26, or the like, data B is preferably acquired from GPS sensor 21, in order to prevent falsification.

When data A and data B are added up to create an ID, as shown in FIG. 4, data A and data B in digitized form are added up. Here, for ease of explanation, the year in data A is omitted.

In this case, the date, that is, a month and a day, are represented by a relative value, with January 1st used as a reference. Specifically, the date is represented by 9-bit numerical data, and January 1st to December 31 are represented by numeric values of 1 to 365. Also, a time, that is, hours, minutes, and seconds, are represented by relative values, with twelve midnight used as a reference. Specifically, the time is represented by 17-bit numerical data, and 00:00:00 a.m. to 11:59:59 p.m. are represented by numeric values of 0 to 86399. In addition, longitude, that is, degrees, minutes, and seconds, are represented by relative values, with a reference point set. Specifically, longitude is represented by 19-bit numeric data, and 0 degrees 0 minutes 0 seconds to 145 degrees 38 minutes 7 seconds are represented by numeric values of 0 to 524287. Furthermore, latitude, that is, degrees, minutes, and seconds, are represented by numeric values, with a reference point set. Latitude is also represented by 19-bit numeric data, and 0 degrees 0 minutes 0 seconds to 145 degrees 38 minutes 7 seconds are represented by numeric values of 0 to 524287.

Based on the result of adding numeric values representing the date, time, longitude, and latitude, from a combination of characters, such as numbers, letters, and symbols, an ID, for example, “ABCDEFG123456” as shown in FIG. 3, is created. Encrypted numeric values, obtained by permuting bits of the numeric data items representing the date, time, longitude, and latitude, may also be added up.

When data A and data B are multiplied together to create an ID, as shown in FIG. 5, data A and data B in digitized form are multiplied together. Again, for ease of explanation, the year in data A is omitted. In this case, since numeric values respectively representing a date, a time, longitude, and latitude are similar to those in the case of creating an ID by adding data A and data B, as shown in FIG. 4, a description of this case is omitted. Based on 64-bit numeric data, which is the result of multiplying the date, time, longitude, and latitude together, from a combination of characters, such as numbers, letters, and symbols, an ID, for example, “ABCDEFG123456” as shown in FIG. 3, is created.

The above described process is summarized below with reference to the flowchart of FIG. 6. As shown in FIG. 6, in step S2-1, the date and time data is acquired. Then, in step S2-2, the coordinate data is acquired. Next, in step S2-3, an ID is calculated.

As described above, in the ID creating-process according to this exemplary embodiment, an ID is created based on data representing the present date and time, and data representing the present position. Accordingly, the possibility that the same single ID is set in different car-mounted apparatuses 14 can be reduced, thus efficiently preventing ID falsification.

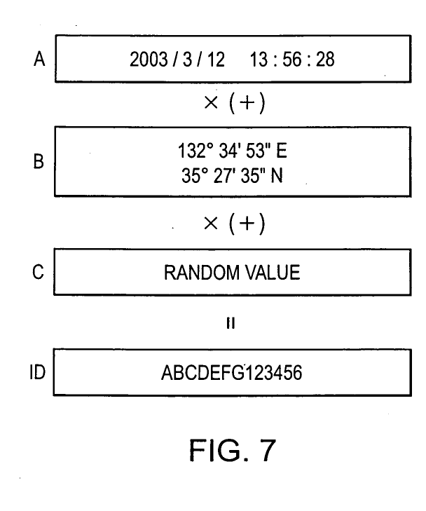

A third exemplary embodiment of the invention is described below with reference to FIG. 7. For those structures identical to structures described in the first and second exemplary embodiments identical reference numerals are used and descriptions thereof are omitted. Also, the operation and advantages identical to those in the first and second embodiments is omitted.

FIG. 7 shows a method for creating an ID unique to the car-mounted apparatus according to the third exemplary embodiment of the invention. In the ID creating process in the second exemplary embodiment, the ID is created based on data representing the present date and time, and data representing the present position. Thus, in a case in which, in each of a plurality of car-mounted apparatuses 14 positioned at almost the same place, the ID creating process is executed at the same time, a single ID is set in the plurality of car-mounted apparatuses 14. Accordingly, in this exemplary embodiment, an ID is created based on data representing the present date and time, data representing the present position, and a randomly acquired numeric value.

As shown in FIG. 7, data A that is date-and-time data representing the present date and time, data B that is coordinate data representing the present position of a car-mounted apparatus 14, and data C that is a random numeric value are acquired, and data A, data B, and data C are added up and/or multiplied together to create an ID. A description of data A and data B is omitted since both are similar to those in the second embodiment.

Data C consists of 4 bytes representing 430,000 random numeric values generated by, for example, a random-number generating algorithm. Based on numeric data obtained by adding up or multiplying together data A, data B, and data C, from a combination of characters, such as numbers, letters, and symbols, an ID, for example, “ABCDEFG123456” shown in FIG. 7, is created.

As described above, in the ID creating process in this exemplary embodiment, an ID is created based on data representing the present date and time, data representing the present position, and a randomly acquired numeric value. Accordingly, even if, in each of a plurality of car-mounted apparatuses 14 positioned at almost the same place, the ID creating process is executed at the same time, a same ID is prevented from being set in both car-mounted apparatuses 14.

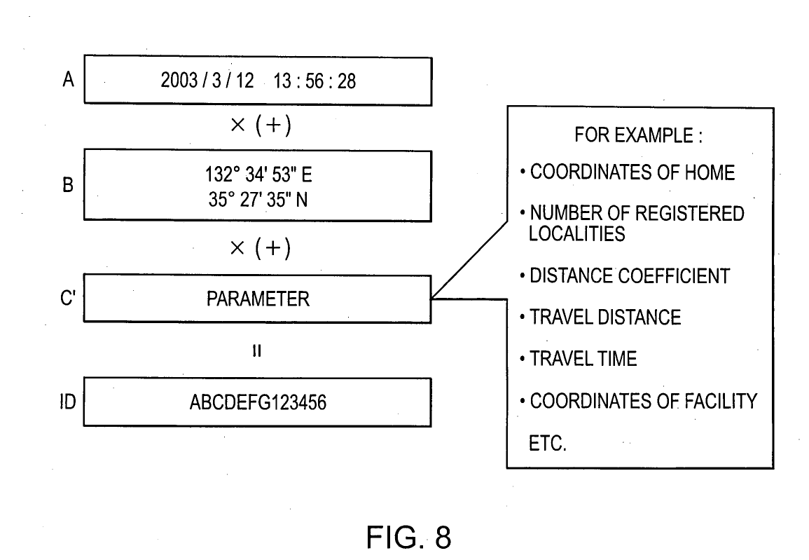

A fourth exemplary embodiment of the invention is described below with reference to FIG. 8. Those structures identical in structure to those described in the first to third embodiments use identical reference numerals and their descriptions are omitted. Also, the operation and advantages identical to those in the first to third embodiments is omitted.

FIG. 8 shows a method for creating an ID unique to a car-mounted apparatus according to the fourth exemplary embodiment of the invention. According to the ID creating process in this exemplary embodiment, instead of the randomly acquired numeric value in the third embodiment, a parameter concerning the car-mounted apparatus 14 is used to create an ID.

As shown in FIG. 8, data A that is date-and-time data representing the present date and time, data B that is coordinate data representing the present position, and data C′ that is a parameter are acquired, and data A, data B, and data C′ are added up and/or multiplied together to create an ID. A description of data A and data B is omitted since both are similar to those in the second embodiment.

Data C′ is an internal parameter concerning the car-mounted apparatus 14, which functions as a navigation apparatus. It is, for example, coordinates of a home which is registered in the car-mounted apparatus 14 beforehand, the number of registered locations, a distance coefficient, a travel distance of the vehicle, a travel time of the vehicle, coordinates of a location where a found facility exists, or the like, and is, represented by a numeric value. Based on numeric data obtained by adding up and/or multiplying together data A, data B, and data C′, from a combination of characters, such as numbers, letters, and symbols, for example, “ABCDEFG123456” shown in FIG. 8, is created as the ID.

As described above, in the ID creating process according to this exemplary embodiment, an ID is created based on data representing the present date and time, data representing the present position, and a parameter concerning the car-mounted apparatus 14. Accordingly, even if, in each of a plurality of car-mounted apparatuses 14 positioned at almost the same place and the ID creating process is executed at the same time, a same ID is prevented from being set in one or more of the plurality of car-mounted apparatuses 14.

As will be understood from the foregoing description, various exemplary embodiments of this invention make it possible to use content, such as various types of data and programs, without a failure in collecting royalties by enabling a unique ID to be set, even an apparatus in which no ID is set during production.

While this invention has been described in conjunction with the exemplary embodiments outlined above, various alternatives, modifications, variations, and/or improvements may be possible. Accordingly, the exemplary embodiments of the invention, as set forth above, are intended to be illustrative. Various changes may be made without departing from the spirit and scope of the invention.

What is claimed is:

1. An ID assigning method, comprising:
recording, in an apparatus, content which is made usable by recording a release key in the apparatus;
recording, in the apparatus, ID setting instructions;
executing the ID setting instructions; and
creating an ID distinctive to the apparatus, the ID usable to acquire the release key.

2. The method of claim 1, wherein the ID is created based on a randomly acquired numeric value.

3. The method of claim 1, wherein the ID is created based on data representing a date and time.

4. The method of claim 1, wherein the ID is created based on data representing a present position.

5. The method of claim 1, wherein the ID is created based on a parameter related to the apparatus.

6. The method of claim 5, wherein the parameter related to the apparatus is a registered home location of the apparatus.

7. The method of claim 5, wherein the parameter related to the apparatus is a number of registered locations stored in the apparatus.

8. The method of claim 5, wherein the parameter related to the apparatus is a distance coefficient.

9. The method of claim 5, wherein the parameter related to the apparatus is a travel distance of a vehicle related to the apparatus.

10. The method of claim 5, wherein the parameter related to the apparatus is a travel time of a vehicle related to the apparatus.

11. The method of claim 5, wherein the parameter related to the apparatus is a location of a found facility.

12. An ID assigning method, comprising:
recording, in an apparatus, ID setting instructions for creating an ID distinctive to the apparatus;
determining a date and time;
determining a present position;
executing the ID setting instructions; and
creating the ID based on data representing the date and time, and data representing the present position.

13. An ID assigning apparatus, comprising a controller, the controller configured to:
record, in the apparatus, content which is made usable by recording a release key in the apparatus;
record, in the apparatus, ID setting instructions;
execute the ID setting instructions; and
create an ID distinctive to the apparatus, the ID usable to acquire the release key.

14. A navigation apparatus comprising the ID assigning apparatus of claim 13.

15. A storage medium storing a set of program instructions executable on a data processing device and usable for assigning an ID to an apparatus, the set of program instructions comprising:
instructions for recording, in the apparatus, content which is made usable by recording a release key in the apparatus;
instructions for recording, in the apparatus, ID setting instructions;
instructions for executing the ID setting instructions; and
instructions for creating an ID distinctive to the apparatus, the ID usable to acquire the release key.
